(19) United States
(12) Patent Application Publication
(10) Pub. No.: US 2019/0281785 A1
(43) Pub. Date: Sep. 19, 2019

(54) FROZEN BUTTER REWORKING PROCESS

(71) Applicant: SPX FLOW TECHNOLOGY DANMARK A/S, Silkeborg (DK)

(72) Inventors: Anders OVESEN, Silkeborg (DK); Bent PEDERSEN, Silkeborg (DK)

(21) Appl. No.: 16/343,453

(22) PCT Filed: Oct. 19, 2017
(86) PCT No.: PCT/DK2017/050346

§ 371 Date: Apr. 19, 2019

(30) Foreign Application Priority Data
Oct. 23, 2016 (DK) PA201600650

(51) Int. Cl. A01J 17/00; A01J 23/00

(52) U.S. Cl. CPC A01J 17/00; A01J 23/00

(57) ABSTRACT

The present disclosure relates to a mechanical frozen butter heater (40), a frozen butter reworking line (2) and a method of reworking frozen butter which are particular in being able to rework frozen butter without the butter having to be cut into chips prior to entry into the mechanical frozen butter heater (40), or the frozen butter reworking line (2) or used in the method of reworking frozen butter according to the invention.

### FIELD

The present invention relates to the field of frozen butter processing and in particular to a method of reworking butter in-line, an in-line butter reworking process line and a butter heater for use with the in-line butter reworking process line.

### BACKGROUND

With increased diversification in food production, many ingredients for final food products, such as e.g. butter, are produced significant distances from their intended sites of use. Butter e.g. are produced for industrial purposes, typically in blocks of 25 kg, at local dairies to avoid transporting the constituent water of the cream over long distances, and transported from the dairies to the industrial consumer usually in a frozen condition at between −25° C. to −15° C. Often, butter leaving dairies has a lower water content than desired by the end consumer, or may be in the need for further processing to improve or change texture and taste, to meet the end consumer's demands.

At the industrial consumer end, butter tempering to temperatures above the freezing point of the water constituent of the butter (i.e. about 0° C.) is often required of the received frozen butter before its entry into industrial production lines, e.g. in industrial scale baking lines where tempered butter is added to dough in dough mixers, or repackaging lines for domestic consumer purposes, e.g. repackaging into consumer suitable packages of e.g. 250 g. Also butter reworking under the addition of water or taste ingredients (often buttermilk, combining both) requires tempered butter to achieve a uniform and homogenous taste and consistency of the reworked butter.

Classically, tempering of frozen butter has been a two-stage process, wherein butter has been allowed to thaw off-line before entry into the production line, usually in designated tempering facilities. However, with the amounts of butter used for industrial production, the storing space needed is large and a significant cost associated with the maintenance of adequate production levels, in particular since unaided thawing is a slow process and therefore requires multiple thawing rooms to meet the demands of a continued, but daily, production.

In recent years, this has led to improvements in in-line tempering of bulk butter and tempering lines for thawed butter at above 0° C. are now commonplace, so-called butter reworking lines. However, as butter for health, storage and handling reasons as described above is normally transported under frozen conditions, the drawback of tempering lines for thawed butter remains the need to provide tempering facilities for frozen butter to become thawed butter.

Such drawbacks and others have led to the creation of in-line butter reworking process lines, wherein frozen butter is directly entered into the process line and thawed, tempered and reworked in a series of consecutive steps to obtain thawed, tempered, and reworked butter suitable for further uses in a desired food process line.

The present invention relates to improvements in butter reworking lines and to improvements to equipment relating to butter reworking, and methods of butter reworking in industrial scale butter reworking lines. In particular, the present invention presents improvements to the processes and to the equipment known in the art for tempering butter from a frozen condition at between −25° C. to −15° C. to butter change-over, i.e. unfrozen or thawed butter at about 0° C.

In general, butter is a complex water-in-oil emulsion wherein the water content by weight can range from as low as 10% to as high as 35% depending on the production method and the intended use. Industrially produced butter for domestic consummation generally comprises less than 20% water by weight. In the United States, products sold as “butter” must contain at least 80% butterfat. In practice, most American butters contain slightly more than that, averaging around 81% butterfat. European butters generally have a higher ratio, up to 85% (Wikipedia, Butter). Further, in many commercial butters, salt is a significant ingredient by weight comprising typically between 0.5 to 5% of the total weight of the butter.

Given the wide ranges of water content in butter, the change-over temperature of butter from a primarily frozen state (all water frozen) to a primarily unfrozen state (all water thawed) is ill-defined. In the art, therefore, it is customarily to speak of the thawing point of butter as butter change-over, with the understanding, that at change-over, a particular butter having a particular butter-fat to water ratio, ceases behaving (mostly) as a particulate compound during flow and forthwith behaves as a homogenous water-in-oil emulsion under flow conditions. The advantage of using a looser terminology, as in change-over rather than thawing, lies in its application also to blended butter products, wherein parts of the butter fat may have been substituted with vegetable oils having thawing points around 0° C., which provides the butter with improved flowability (often spreadability at refrigerated) (+5°) conditions) but also may lower the thawing point of the blended butter product to below 0° C. In the present context, thawing is used as referring to the melting of frozen water, not to the melting of butter fat itself, which does not occur until about 32-35° C.

Accordingly, in the present context, butter is to be understood in a first instance as a water-in-oil emulsion comprising by weight at least 65% butter fat and less than 35% water, preferably as a water-in-oil emulsion comprising at least 75% butter fat and less than 25% water, and most preferably as a water-in-oil emulsion comprising at least 80% butter fat and less than 20% water. Butter as described above will be suitable for use with the butter reworking line of the present invention and the method of reworking butter disclosed herein. No particular importance is placed on the source of the butter fat, nor the protein content of the butter, but in most instances, salt will be present in non-negligible amounts (i.e. sufficient to induce a thawing point depression in crystallized water), such as less than 5% salt by weight of the butter, but usually between 0.5% to 4%, more usually between 1% to 2.5% by weight of butter. Also non-negligible amounts of vegetable fat may be present in the “butter” (thereby forming a butter blend) without the “butter” becoming unsuitable for use in the method of the present invention and the butter reworking line.

Essentially, however, is that the butter in the context of the invention shall form a solid, non-flowing mass at temperatures below −25° C., below −20° C., preferably below −18° C. and most preferably below −15° C., which upon heating to about 0° C. crosses over into a pumpable, homogenous water-in-oil emulsion comprising at least 65% butter fat and less than 35% water by weight of butter.

In the art of in-line frozen butter reworking and butter thawing several manufacturers, including the present applicant, manufacture and sell such installation for reworking blocks of butter. An early installation to Egli is described in WO 89/10689, wherein large, deep frozen blocks of butter with a desired moisture content are reworked by chipping them in a butter chipper while adding metered quantities of water. The frozen butter chips are then fed through a vacuum region into a butter churn designed as a continuous kneading mill. The butter chips are continuously conveyed under pressure through the kneading mill by means of a high-pressure butter pump. The addition of liquid water facilitates the thawing of the butter in the process, however is undesirable where a fixed water content is desired in the thawed butter. Other installations of the type described in WO 89/10689 are manufactured and sold by Simon Freres S.A. and Rothenburg GmbH. Also frozen butter reworking lines comprising butter heat exchangers are known, but due to limitations to mixing and heat transport, the frozen butter is unevenly heated which restricts the use of this method to small production capacities.

It has been a persistent problem within the field of in-line butter reworking that the use of butter chips causes increased moisture loss from the butter in the chipping process and increased air inclusion into the butter at the later kneading and reformation of a homogenous butter mass. These effects are undesired since in many applications, such as e.g. repackaging of butter, changes to composition and consistency during reworking may be unacceptable from a consumer viewpoint or by the authorities.

To this end, the present applicant has introduced a frozen butter reworking line in 2014 comprising an auger for supplying frozen butter blocks to a high pressure butter pump in pumpable condition followed by a sequence of three butter extruders (SPX Gerstenberg Dynamic Mixers BMX) arranged at right angles to each other thereby providing a meandering butter flow path for imparting mechanical energy to the frozen butter for thawing the same butter. While the reworking line introduced by applicant on the market in 2014 solved some of the drawbacks relating to water loss and air inclusion present in the prior art butter chip reworking lines of the type described in WO 89/10689, the butter reworking line of 2014 requires the auger and butter pump to operate at unacceptable high pressures to compensate for the pressure losses across the three butter extruders. A further drawback of Applicant's 2014 setup was that depending on water content, not all butters would have adequately thawed (change-over) after passage of the third extruder. The present invention relates to improvements to the 2014 reworking line by applicant which do not suffer from these drawbacks, while maintaining the advantages with respect to low water loss and low air inclusion over the butter chip reworking lines of the type described in WO 89/10689. In GB 1268873 a frozen butter heater is disclosed comprising a mixer housing comprising a cavity arranged on a butter flow path between a housing entry and a housing exit, where in the cavity there are arranged two axles across the butter flow path. The axles each comprise a plurality of breaker arms.

The process and installation for butter thawing and reworking of the present invention are detailed in the below description, claims and figures, which are herewith incorporated by reference.

### SUMMARY OF THE INVENTION

In a first aspect of the present invention there is detailed a frozen butter heater (40) of the which comprises a mixer housing (43) comprising a cavity (45) arranged on a butter flow path between a housing entry (41) and a housing exit (42), where in the cavity (45) there is arranged an axle (50) across the butter flow path, the axle (50) comprising a plurality of cogwheels (51a, 51b, 51c, 51d) arranged co-axially with the axle between a set of butter seals (54a, 54b), the axle (50) rotably supported on bearings arranged in at least one bearing house (44a, 44b) arranged adjacent to said mixer housing (43), and operatively connected to a drive motor (52), wherein the drive motor (52) is arranged to maintain a rotational velocity of the axle (50) against a flow of frozen butter of between 1200 rpm to 2500 rpm.

In a second aspect of the present invention there is detailed a frozen butter reworking line (2) comprising an auger pump (10); a butter pump (20); at least three frozen butter heaters (40a, 40b, 40c, 40d, 40f) according to any of the above embodiments; and a flow path for allowing frozen butter to enter said frozen butter reworking line (2) at said auger pump (10), and exit the frozen butter reworking line (2) after change-over into thawed butter after passage of the at least three butter heaters (40a, 40b, 40c, 40d, 40f), and wherein the flow pressure supplied by said butter pump (20) does not exceed 20 bar.

In a third aspect of the invention there is detailed a method of reworking blocks of frozen butter having a temperature between −25° C. to −15° C. in a frozen butter reworking line (2) defining a flow path for butter to obtain change-over to unfrozen butter comprising: providing blocks of frozen butter to an auger pump (10) to provide a flow of a mass of frozen butter to a butter pump (20); raising a pressure of the flow of a mass of frozen butter in the butter pump (20) to between 10 to 30 bar; supplying the flow of a mass of frozen butter to a sequence of at least three consecutively arranged frozen butter heaters (40a, 40b, 40c, 40d, 40e), each butter heater comprising an axle (50) arranged transversally to the flow path for butter and comprising a plurality of cogwheels (51a, 51b, 51c, 51d) arranged co-axially with the axle; rotating a said axle (50) on a respective frozen butter heater (40a, 40b, 40c, 40d, 40e) at between 1200 rpm to 2500 rpm to mechanically impact heat to the flow of a mass of frozen butter until a change-over to unfrozen butter is observed.

### BRIEF DESCRIPTION OF THE DRAWINGS

FIG. 1: A frozen butter reworking line according to the prior art (A) and extruder part of prior art butter extruder (B).

FIG. 2: An Auger and butter loader for use with the present invention.

FIG. 3: A frozen butter mixer according to the invention.

FIG. 4: A frozen butter reworking line according to the invention.

FIG. 5: An augmented prior art frozen butter reworking line.

### DETAILED DESCRIPTION

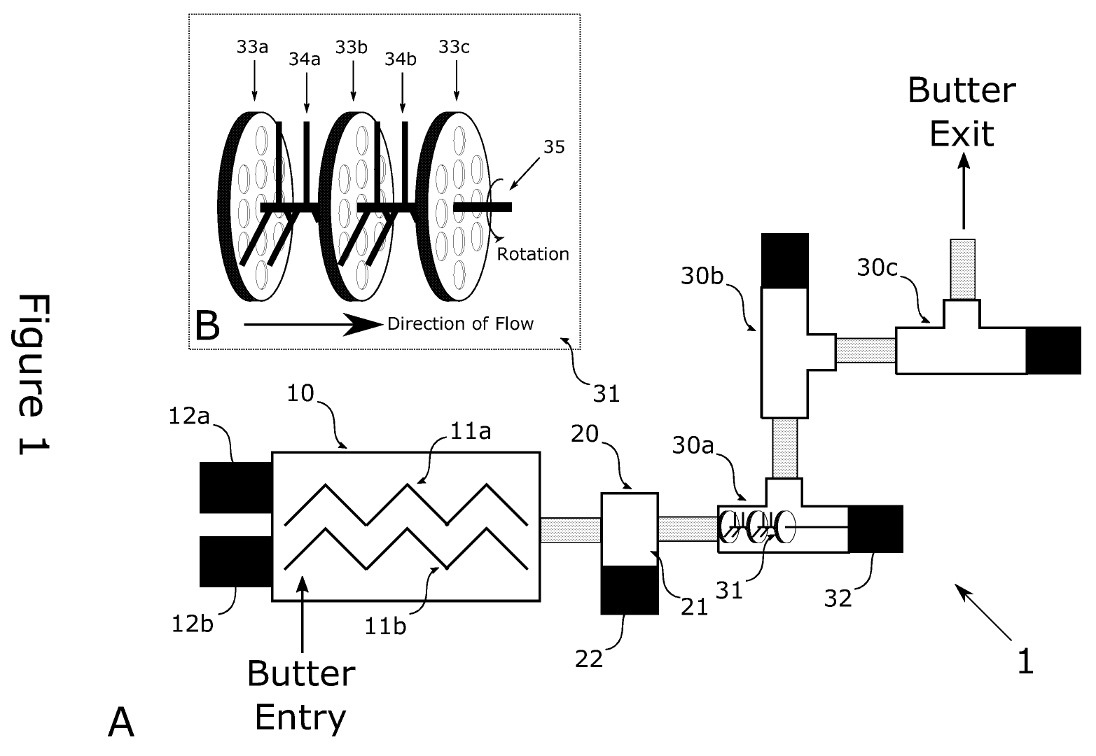

FIG. 1 details the frozen butter reworking line (1) according to Applicant's own prior art frozen butter reworking line. An auger pump (10) comprising two counter-rotating augers (11a, 11b) and respective drive motors (12a, 12b) supplies frozen butter in pumpable condition to a high pressure conventional butter pump (20) comprising a pump gears (21) and a drive motor (22).

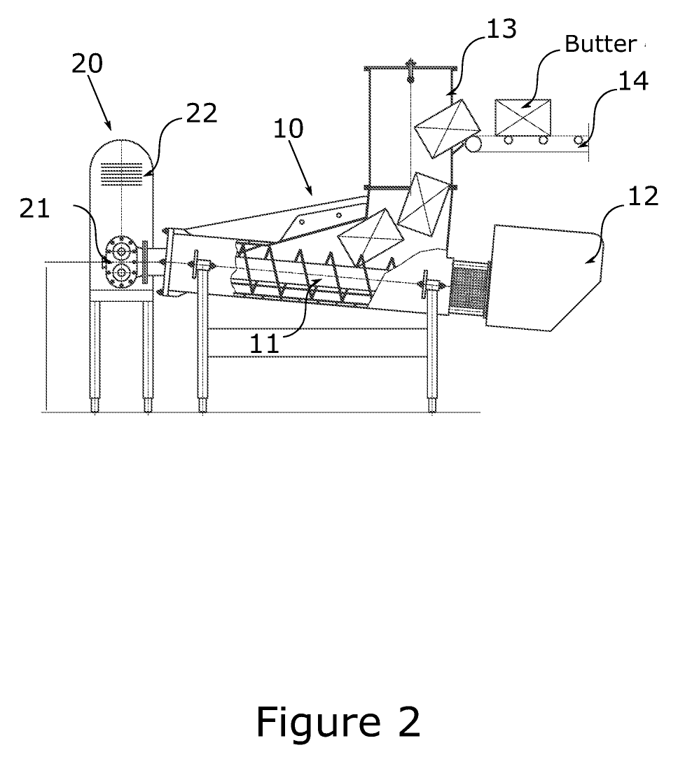

FIG. 2 shows the auger pump (10) and the butter pump (20) in more detail. The auger pump (10) can be loaded with butter manually, but preferably a conveyor belt (14) feeds the frozen butter to a butter silo (13) prior to entry into the auger pump. In the auger pump the frozen butter blocks are mechanically reduced to a pumpable mass of frozen butter without significantly increasing the surface of the butter. This reduces water loss and air inclusion. The auger (10) and butter pump (20) setup shown in FIG. 2 is common to both the prior art frozen butter reworking line of applicant and the present invention. During operation, the butter pump (20) provides the flow of butter with a flow pressure above 30 bar in the prior art examples. Below such flow pressures of 30 bar, the prior art frozen butter reworking line (1) would not retain a sufficient flow pressure for the butter to traverse the reworking line (1).

In FIG. 1 the butter extruders (30) (SPX Gerstenberg Dynamic Mixers BMX) are further detailed and their arrangement within the frozen butter reworking line (1) of the prior art shown. The BMX-extruder, an existing product by Applicant, conveys the extruded butter out of the extruder (30) at right angles due to the manner in which it has been constructed. For this reason the three extruders (30a, 30b, 30c) are arranged at right angles to each other thereby providing a meandering butter flow path. The BMX-extruder (30) is constructed to comprise in an extrusion chamber (31) a set of three consecutively arranged extrusion discs with throughholes (33a, 33b, 33c) positioned in the extrusion chamber (31) at right angles to the flow path of the butter. Between the extrusion discs (33a, 33b, 33c) are arranged two sections of rotating butter beaters (34a, 34b) arranged on a common axis (35) which attaches to a drive motor (32) for rotating the butter beaters (34a, 34b), while butter is passing the extruder (30). When frozen butter passes the extruder (30), in particular the extrusion discs (33a, 33b, 33c) and the 90° exit pipe constitute large flow obstructions requiring very high exit pressures (in excess of 40 bar) from the butter pump for frozen butter to traverse the meandering flow path.

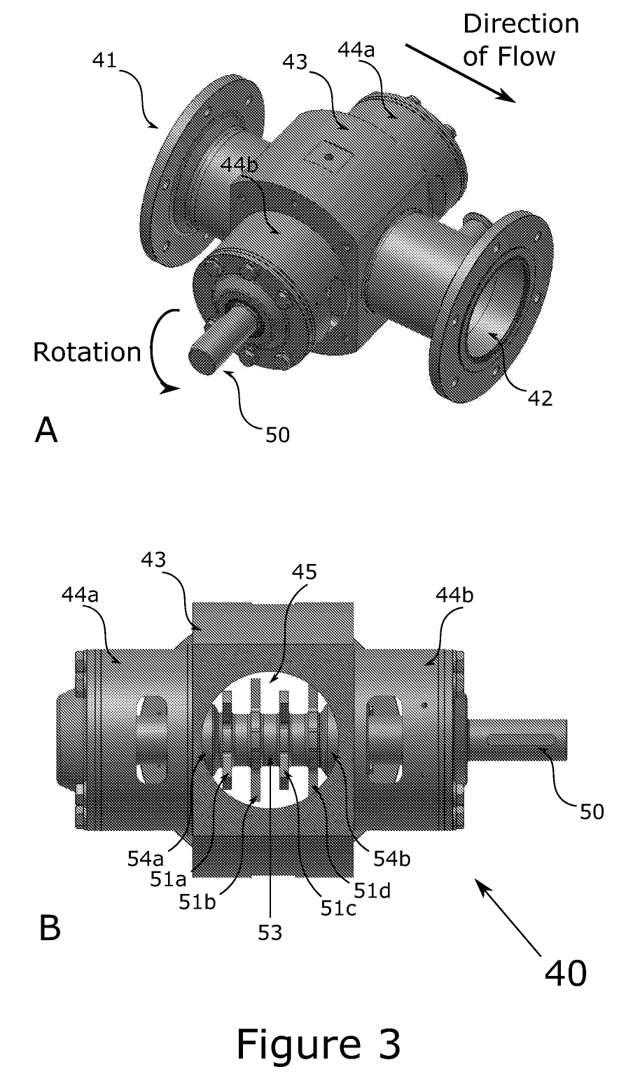

FIG. 3 details the improved mechanical frozen butter heater (40) of the present invention. The frozen butter heater (40) of the present invention comprises a mixer housing (43) comprising a cavity (45) arranged on a butter flow path between a housing entry (41) and a housing exit (42), where in the cavity (45) there is arranged an axle (50) across the butter flow path, the axle (50) comprising a plurality of cogwheels (51a, 51b, 51c, 51d) arranged co-axially with the axle between a set of butter seals (54a, 54b), the axle (50) rotably supported on bearings arranged in at least one bearing house (44a, 44b) arranged adjacent to said mixer housing (43), and operatively connected to a drive motor (52), wherein the drive motor (52) is arranged to maintain a rotational velocity of the axle (50) against a flow of frozen butter of between 1200 rpm to 2500 rpm. In one embodiment, the cogwheels are spaced apart by a small interspace (53).

The frozen butter heater (40) of the present invention is of a simple mechanical construction and hence offers few constructive parts which can break while imparting mechanical energy to the frozen butter during use. In use, frozen butter traverses the butter heater (40) which is set to rotate at between 1200 to 2500 rpm against the frozen butter, whereby the cogs of the cogwheels beat the frozen butter at high speed and thereby homogenously imparts mechanical energy to the butter, thus heating the butter. As the cogwheels will rotate with the flow of the butter, the flow resistance posed by the present butter heater is much less than the butter heaters of the prior art, which alleviates the need to operate the butter pump (20) at very high pumping pressures.

The choice of the rotational velocity is important, as it will serve to heat the butter while limiting the demixing of water from the water-in-oil emulsion to a minimum. It is intended that the rotational velocity shall be between 1200 rpm to 2500 rpm, preferably between 1200 rpm to 2000 rpm, more preferably between 1300 rpm to 1800 rpm and most preferably between 1400 rpm to 1600 rpm. Particularly preferred is 1500 rpm.

The construction, being mechanically simple, requires few parts, each part individually known to the skilled person. It is important, that the cogs of the cogwheels be of sufficient thickness to avoid fatigue failure, but the skilled person will know how to dimension the cogs accordingly. In fact, erring on the side of caution, when dimensioning the cogs, is quite advantageous as this will allow more mechanical energy to be imparted to the frozen butter by the butter heater. Likewise, the construction of bearings and such to allow the axle (50) to rotate at between 1200 rpm and 2500 rpm when submersed in frozen butter is within the skills of the artisan. Notably though, it is advantageous to include a means for feedback in the drive motor (52), e.g. for measuring the torque on the axle (50). In this manner, the power output from the drive motor (52) can be automatically adjusted during butter heating to allow continued operation at a chosen rotational velocity in response to the heating of the butter, and further, as will be shown in the examples, the time to change-over of the butter, and the energy required can be determined.

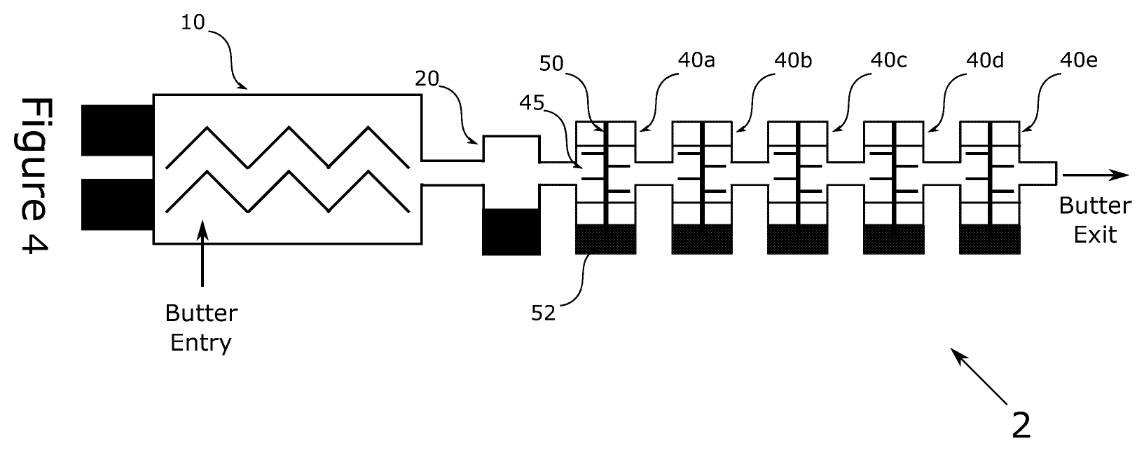

FIG. 4 details the frozen butter reworking line (2) of the present invention. The frozen butter reworking line (2) comprises an auger pump (10) and a butter pump (20) as detailed above, preferably the auger pump (10) comprises two counter-rotating augers (11a, 11b) for increased efficiency, at least three frozen butter heaters (40a, 40b, 40c, 40d, 40f) as detailed above, and a flow path for allowing frozen butter to enter the frozen butter reworking line (2) at the auger pump (10) and exit the frozen butter reworking line (2) after change-over into thawed butter after passage of the at least three butter heaters.

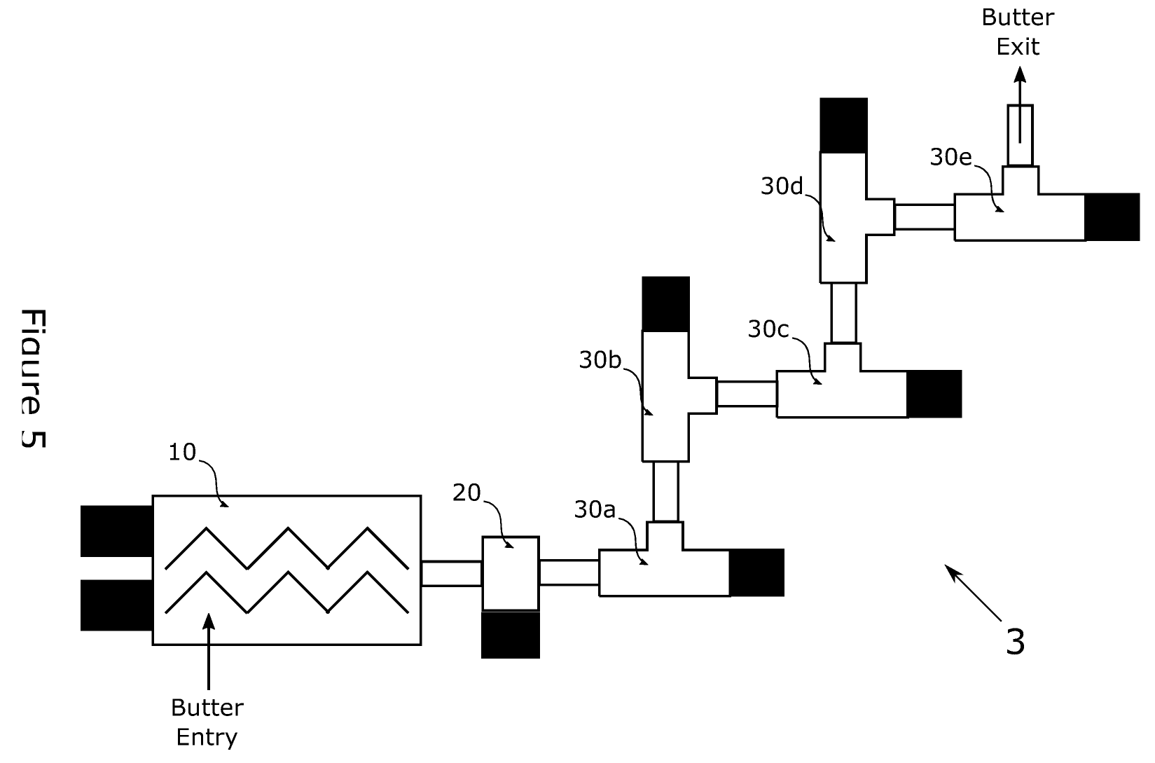

FIG. 5 details a frozen butter reworking line (3) comparable to the frozen butter reworking line (2) of the invention, adapted from the prior art frozen butter reworking line (1) of the Applicant. The examples below provide a comparison between the experimental output of the frozen butter reworking line (2) of the invention and of the adapted prior art frozen butter reworking line (3).

In a first embodiment there is detailed a frozen butter reworking line (2) comprising an auger pump (10); a butter pump (20); at least three frozen butter heaters (40a, 40b, 40c, 40d, 40f) according to any of the above embodiments; and a flow path for allowing frozen butter to enter said frozen butter reworking line (2) at said auger pump (10), and exit the frozen butter reworking line (2) after change-over into thawed butter after passage of the at least three butter heaters (40a, 40b, 40c, 40d, 40f), and wherein the flow pressure supplied by said butter pump (20) does not exceed 20 bar.

In particular there is detailed according to the present invention a frozen butter reworking line (2) comprising an auger pump (10); a butter pump (20); at least three frozen butter heaters (40a, 40b, 40c, 40d, 40f), each frozen butter heater (40) comprising a mixer housing (43) comprising a cavity (45) arranged on a butter flow path between a housing entry (41) and a housing exit (42), where in the cavity (45) there is arranged an axle (50) across the butter flow path, the axle (50) comprising a plurality of cogwheels (51a, 51b, 51c, 51d) arranged co-axially with the axle between a set of butter seals (54a, 54b), the axle (50) rotably supported on bearings arranged in at least one bearing house (44a, 44b) arranged adjacent to said mixer housing (43), and operatively connected to a drive motor (52), wherein the drive motor (52) is arranged to maintain a rotational velocity of the axle (50) against a flow of frozen butter of between 1200 rpm to 2500 rpm; and a flow path for allowing frozen butter to enter said frozen butter reworking line (2) at said auger pump (10), and exit the frozen butter reworking line (2) after change-over into thawed butter after passage of the at least three butter heaters (40a, 40b, 40c, 40d, 40f), and wherein the flow pressure supplied by said butter pump (20) does not exceed 20 bar.

In one embodiment there is detailed a frozen butter reworking line (2), wherein the auger pump (10) further comprises a butter silo (13).

In another embodiment there is detailed a frozen butter reworking line (2) wherein the auger pump (10) comprises two counter-rotating augers (11a, 11b).

In a further embodiment there is detailed a frozen butter reworking line (2) according to any of previous embodiments, wherein the flow pressure supplied by the butter pump (20) across any of the at least three frozen butter heaters (40a, 40b, 40c, 40d, 40f) does not exceed 20 bar, when the butter heaters are operated at a rotational velocity of between 1200 to 2500 rpm.

In a further embodiment there is detailed a frozen butter reworking line (2) according to any of the previous embodiments, further comprising a butter extruder (30) arranged on the butter flow path after the at least three frozen butter heaters (40a, 40b, 40c, 40d, 40f). Thereby the homogeneity of the thawed butter can be improved.

In a further embodiment there is detailed a frozen butter reworking line (2) according to any of the previous embodiments, further comprising entry flow paths for taste ingredients and/or water arranged on the butter flow path after butter pump (20) or in between the at least three frozen butter heaters (40a, 40b, 40c, 40d, 40f). Thereby post-processing of the butter can be avoided.

Further, and according to the invention there is detailed a method of reworking blocks of frozen butter having a temperature between −25° C. to −15° C. in a frozen butter reworking line (2) defining a flow path for butter to obtain change-over to unfrozen butter comprising: providing blocks of frozen butter to an auger pump (10) to provide a flow of a mass of frozen butter to a butter pump (20); raising a pressure of the flow of a mass of frozen butter in the butter pump (20) to between 10 to 30 bar; supplying the flow of a mass of frozen butter to a sequence of at least three consecutively arranged frozen butter heaters (40a, 40b, 40c, 40d, 40e), each butter heater comprising an axle (50) arranged transversally to the flow path for butter and comprising a plurality of cogwheels (51a, 51b, 51c, 51d) arranged co-axially with the axle; rotating a said axle (50) on a respective frozen butter heater (40a, 40b, 40c, 40d, 40e) at between 1200 rpm to 2500 rpm to mechanically impact heat to the flow of a mass of frozen butter until a change-over to unfrozen butter is observed.

In one embodiment, the method of reworking blocks of frozen butter as disclosed above, the mass of frozen butter is a continuous mass of frozen butter. Preferably the continuous mass of frozen butter is supplied the frozen butter reworking line (2) at a flow rate of between 2000 kg/hour to 5000 kg/hour, preferably 4000 kg/hour. Preferably the blocks of frozen butter have a weight of at least 5 kg, preferably of 25 kg.

In a further embodiment there is detailed a method of reworking blocks of frozen butter, wherein the pressure of the flow of a mass of frozen butter is raised in the butter pump (20) to between 10 to 20 bar.

In a further embodiment there is detailed a method of reworking blocks of frozen butter, wherein a said axle (50) on a respective frozen butter heater (40a, 40b, 40c, 40d, 40e) is rotating at preferably between 1200 rpm to 2000 rpm, more preferably between 1300 rpm to 1800 rpm and most preferably between 1400 rpm to 1600 rpm. Particularly preferred is 1500 rpm.

In a further embodiment there is detailed a method of reworking blocks of frozen butter, wherein the frozen butter heater (40a, 40b, 40c, 40d, 40e) is a frozen butter heater (40) according to any of the embodiments detailed above.

In a further embodiment there is detailed a method of reworking blocks of frozen butter according to any embodiments above, wherein the frozen butter reworking line (2) is a frozen butter reworking line (2) according to any of the above embodiments.

The term “comprising” as used in the claims does not exclude other elements or steps. The term “a” or “an” as used in the claims does not exclude a plurality.

Although the present invention has been described in detail for purpose of illustration, it is understood that such detail is solely for that purpose, and variations can be made therein by those skilled in the art without departing from the scope of the invention.

### Examples

The frozen butter reworking line (2) was tested in comparative experiments with an augmented frozen butter reworking line (3) comprising two additional BMX-mixers compared to Applicant's marketed frozen butter reworking line (1).

In all examples, the butter tested was 25 kg block of Danish standard commercial butter, 82% butter fat, 16% water, 1.2% salt, 0.7% carbohydrates and 0.6% protein by weight of total butter.

### Comparative Test 1:

| | | | | | | |
|---|---|---|---|---|---|---|
| Butter Temp. | Butter Temp. | Pressure | Pressure | Power | Butter | |
| at entry | at exit | at entry | at exit | consumption | condition | Flow rate |
| [° C.] | [° C.] | [bar] | [bar] | [kW] | at exit | [kg/h] |

Augmented Prior Art Process line (values are average during 15 min.) - cf. FIG. 5

| | | | | | | | |
|---|---|---|---|---|---|---|---|
| Augers: | −17 | | 1 | | 34 | Frozen Butter | 3800 |
| Heater 1 | | | 38 | | 17 | Frozen Butter | |
| | | | 48 (peak) | | | | |
| Heater 2 | | | | 17 | 18 | Frozen Butter | |
| Heater 3 | | | 17 | | 13 | Frozen Butter | |
| Heater 4 | | | | | 12 | Change over | |
| Heater 5 | | 8 | | 9 | 13 | Refrigerated | |
| | | | | | | Butter | |

New Process line (values are average during 15 min.) - cf. FIG. 4

| | | | | | | | |
|---|---|---|---|---|---|---|---|
| Augers: | −18 | | 1 | | 30 | Frozen Butter | 4000 |
| Heater 1 | | | 18 | 16 | 25 | Frozen Butter | |
| | | | 30 (peak) | | | | |
| Heater 2 | | | 16 | 14 | 25 | Frozen Butter | |
| Heater 3 | | | 14 | 13 | 15 | Change over | |
| Heater 4 | | | 13 | 12 | 15 | Refrigerated | |
| | | | | | | Butter | |
| Heater 5 | | 8 | 12 | 9 | 10 | Refrigerated | |
| | | | | | | Butter | |

### Comparative Test 2:

| | | | | | | |
|---|---|---|---|---|---|---|
| Butter Temp. | Butter Temp. | Pressure | Pressure | Power | Butter | |
| at entry | at exit | at entry | at exit | consumption | condition | Flow rate |
| [° C.] | [° C.] | [bar] | [bar] | [kW] | at exit | [kg/h] |

Augmented Prior Art Process line (values are average during 15 min.) - cf. FIG. 5

| | | | | | | | |
|---|---|---|---|---|---|---|---|
| Augers: | −17 | | 1 | | 34 | Frozen | 3800 |
| Heater 1 | | | 38 | | 17 | Frozen | |
| | | | 48 (peak) | | | | |
| Heater 2 | | | | 17 | 18 | Frozen | |
| Heater 3 | | | 17 | | 13 | Frozen | |
| Heater 4 | | | | | 12 | Change over | |
| Heater 5 | | 8 | | 9 | 13 | Refrigerator | |

New Process line (values are average during 15 min.) - cf. FIG. 4

| | | | | | | | |
|---|---|---|---|---|---|---|---|
| Augers: | −18.7 | | 1 | | 34 | Frozen | 4216 |
| Heater 1 | | | 16.9 | 14.3 | 19 | Frozen | |
| | | | 31.8 (peak) | | | | |
| Heater 2 | | | 14.3 | 12.2 | 11 | Frozen | |
| Heater 3 | | | 12.2 | 11.0 | 15 | Frozen | |
| Heater 4 | | | 11.0 | 9.9 | 12 | Change over | |
| Heater 5 | | 5.6 | 9.9 | 5.4 | 10 | Refrigerator | |

From the tables and tests it can be observed that, apart from a peak in the pressure across the first heater during start-up, the pressure across the reworking line (2) for the reworking line (2) of the invention stays below 20 bar and that the total pressure drop for the reworking line (2) of the invention is on the order of 10 bar or below, whereas the comparative reworking line (3) requires the butter pump to produce more than 30 bar of pressure (38 bars) during operation of the comparative reworking line (3) and further, the total pressure drop across the comparative reworking line (3) is on the order of 30 bars.

Power consumption for the reworking line (2) of the invention is somewhat larger, which is consistent with less energy being impacted to the butter through pressure loss across the reworking line and more energy being impacted by increased efficiency of the butter heaters (40) of the invention. This effect is beneficial as the change-over can thereby be controlled more efficiently.

The butter heaters (40) of the invention were operating at 1500 rpm in both tests. No significant loss of water or inclusion of air was observed in the reworked butter.

It is notable, that at a flow rate of about 4000 kg/hour, the augmented prior art reworking line (3) could not achieve change-over with three butter extruders (30), but had to rely on a further extruder to achieve change-over at this production rate. Applicant has observed change-over in his prior art reworking line (1) only at lower flow rates of less than 2000 kg/hour of butter.

1. A frozen butter heater (40) comprising a mixer housing (43) comprising a cavity (45) arranged on a butter flow path between a housing entry (41) and a housing exit (42); where in said cavity (45) there is arranged an axle (50) across said butter flow path, said axle (50) comprising a plurality of cogwheels (51a, 51b, 51c, 51d) arranged co-axially with said axle between a set of butter seals (54a, 54b); said axle (50) rotably supported on bearings arranged in at least one bearings house (44a, 44b) arranged adjacent to said mixer housing (43), and operatively connected to a drive motor (52); wherein said drive motor (52) is arranged to maintain a rotational velocity of said axle (50) of between 1200 rpm to 2500 rpm against a flow of frozen butter.

2. A frozen butter heater (40) according to claim 1, wherein said cogwheels are spaced apart by a small interspace (53).

3. A frozen butter heater (40) according to claim 1, wherein said drive motor (52) comprises a means for feedback operatively connected to said drive motor (52) for automatically adjusting a power output from said drive motor (52) thereby allowing continued operation at a chosen rotational velocity in response to a temperature change in said butter.

4. A frozen butter heater (40) according to claim 3, wherein said means for feedback is a means for measuring the torque on the axle (50).

5. A frozen butter reworking line (2) comprising an auger pump (10); a butter pump (20); at least three frozen butter heaters (40a, 40b, 40c, 40d, 40f) according to claim 1; and a flow path for allowing frozen butter to enter said frozen butter reworking line (2) at said auger pump (10), and exit the frozen butter reworking line (2) after change-over into thawed butter after passage of the at least three butter heaters (40a, 40b, 40c, 40d, 40f), and wherein the flow pressure supplied by said butter pump (20) does not exceed 20 bar.

6. A frozen butter reworking line (2) according to claim 5, wherein said auger pump (10) further comprises a butter silo (13).

7. A frozen butter reworking line (2) according to claim 5, wherein said auger pump (10) comprises two counter-rotating augers (11a, 11b).

8. A frozen butter reworking line (2) according to claim 5, wherein the flow pressure supplied by said butter pump (20) across any of said at least three frozen butter heaters (40a, 40b, 40c, 40d, 40f) does not exceed 20 bar, when said butter heaters are operated at a rotational velocity of between 1200 to 2500 rpm.

9. A frozen butter reworking line (2) according to claim 5, further comprising a butter extruder (30) arranged on said butter flow path after said at least three frozen butter heaters (40a, 40b, 40c, 40d, 40f).

10. A frozen butter reworking line (2) according to claim 5, further comprising entry flow paths for taste ingredients and/or water arranged on the butter flow path after butter pump (20) or in between the at least three frozen butter heaters (40a, 40b, 40c, 40d, 40f).

11. A method of reworking blocks of frozen butter having a temperature between −25° C. to −15° C. in a frozen butter reworking line (2) defining a flow path for butter to obtain change-over to unfrozen butter comprising:
providing blocks of frozen butter to an auger pump (10) to provide a flow of a mass of frozen butter to a butter pump (20);
raising a pressure of said flow of a mass of frozen butter in said butter pump (20) to between 10 to 30 bar;
supplying said flow of a mass of frozen butter to a sequence of at least three consecutively arranged frozen butter heaters (40a, 40b, 40c, 40d, 40e), each butter heater comprising an axle (50) arranged transversally to said flow path for butter and comprising a plurality of cogwheels (51a, 51b, 51c, 51d) arranged co-axially with said axle;
rotating a said axle (50) on a respective frozen butter heater (40a, 40b, 40c, 40d, 40e) at between 1200 rpm to 2500 rpm to mechanically impact heat to said flow of a mass of frozen butter until a change-over to unfrozen butter is observed.

12. A method of reworking blocks of frozen butter according to claim 11, wherein said mass of frozen butter is a continuous mass of frozen butter.

13. A method of reworking blocks of frozen butter according to claim 12, wherein said continuous mass of frozen butter is supplied at a flow rate of between 2000 kg/hour to 5000 kg/hour, preferably 4000 kg/hour.

14. A method of reworking blocks of frozen butter according to claim 11, wherein said blocks of frozen butter have a weight of at least 5 kg, preferably of 25 kg.

15. A method of reworking blocks of frozen butter according to claim 11, wherein said pressure of said flow of a mass of frozen butter is raised in said butter pump (20) to between 10 to 20 bar.

16. A method of reworking blocks of frozen butter according to claim 11, wherein a said axle (50) on a respective frozen butter heater (40a, 40b, 40c, 40d, 40e) is rotating at between 1200 rpm to 2000 rpm, preferably at 1500 rpm.

17. A method of reworking blocks of frozen butter according to claim 11, wherein a said frozen butter heater (40a, 40b, 40c, 40d, 40e) is a frozen butter heater (40) according to claim 1.

18. A method of reworking blocks of frozen butter according to claim 11, wherein a said frozen butter reworking line (2) is a frozen butter reworking line (2) according to claim 5.
